(19) United States
(12) Patent Application Publication
(10) Pub. No.: US 2013/0317941 A1
(43) Pub. Date: Nov. 28, 2013

(54) Trust Graph

(71) Applicants: Nathan Stoll, San Francisco, CA (US); Jan Magnus Stensmo, Foster City, CA (US)

(72) Inventors: Nathan Stoll, San Francisco, CA (US); Jan Magnus Stensmo, Foster City, CA (US)

(21) Appl. No.: 13/769,181

(22) Filed: Feb. 15, 2013

Related U.S. Application Data
(60) Provisional application No. 61/648,578, filed on May 17, 2012.
(60) Provisional application No. 61/648,591, filed on May 17, 2012.
(60) Provisional application No. 61/688,655, filed on May 18, 2012.

(51) Int. Cl. G06Q 30/06

(52) U.S. Cl. CPC G06Q 30/0609
USPC 705/26.35

(57) ABSTRACT

In accordance with some implementations, a method for storing levels of trust between users for use in online e-commerce is disclosed. The method is performed on a server system having one or more processors and memory storing one or more programs for execution by the one or more processors. The server system stores trust information for a plurality of users, wherein each user has an associated level of trust with one or more other users in the plurality of users. The server system receives, from a first user, a trust indication for a second user in the plurality of users. The server system then updates the trust information of the first user based on the trust indication.

### RELATED APPLICATIONS

This application claims priority to U.S. Provisional Patent Application Nos. 61/648,578, “Trust Graphs,” filed May 17, 2012; 61/648,591, “System And Method For Social Network Based Referrals,” filed May 17, 2012; 61/688,655, and “System And Method For Social Network Based Referrals,” filed May 18, 2012. All of these applications are incorporated by referenced herein in their entirety.

### TECHNICAL FIELD

The disclosed implementations relate to the field of online commerce generally and in particular to using trust connections to improve user experiences.

### BACKGROUND

Over the last two decades, the buying and the selling of products through computer networks such as the Internet has increased dramatically. A significant portion of all commerce is now conducted online through the Internet. As the amount of commerce conducted online grows, the number of online commerce venues also grows. As such, online vendors compete with each other to offer users the best user experience. One way to differentiate from other online retails is to provide products most suitable to the needs of the users.

Purchasing goods and services online has advantages and drawbacks. Purchasing goods online allows consumers to shop and compare products easily from their own home. Additionally, consumers have a much wider selection of goods available for selection. Thus, consumers can quickly search through and review literally millions of options.

However, when shopping online the social aspects of more traditional commerce are lost. The large number of options available to consumers at any given time can result in difficulty in finding the optimal answer to the user's problem. Traditionally, consumers can rely on social structures to help evaluate different options when shopping. For example, when shopping in a retail store, shoppers can get purchasing advice from sales people or friends and family that accompany them. Shopping online removes this social experience as it is typically done alone.

Additionally, purchasing goods and services online can be more complicated than purchasing goods in person. For example, purchasing online often involves filling out extensive forms, manually inputting payment methods, and arranging for shipping of the product. Then, unlike traditional shopping, the purchaser must wait for delivery of the good. As such, online commerce websites need to focus on the advantages of shopping online, while also minimizing the disadvantages.

Another significant use of computer networks, such as the Internet, is computer based social networking. Websites like Facebook allow their users to find and maintain relationships with other people through status updates and messages. Users can keep generally aware of the lives of friends, family members, and acquaintances that would otherwise be difficult to keep in close contact with.

### SUMMARY

In accordance with some implementations, a method for storing levels of trust between users for use in commerce is disclosed. The method is performed on a server system having one or more processors and memory storing one or more programs for execution by the one or more processors. The server system stores trust information for a plurality of users, wherein each user has an associated level of trust with one or more other users in the plurality of users. The server system receives, from a first user, a trust indication for a second user in the plurality of users. The server system then updates the trust information of the first user based on the trust indication.

In accordance with some implementations, a server system for storing levels of trust between users for use in commerce is disclosed. The server system has one or more processors, and memory storing one or more programs to be executed by the one or more processors. The one or more programs include instructions for storing trust information for a plurality of users, wherein each user has an associated level of trust with one or more other users in the plurality of users. The server system includes instructions for receiving, from a first user, a trust indication for a second user in the plurality of users. The server system includes instructions for updating the trust information of the first user based on the trust indication.

In accordance with some implementations, a non-transitory computer readable storage medium storing one or more programs configured for execution by a server system is disclosed. The one or more programs also include instructions for storing levels of trust between users for use in commerce. The one or more programs further include instructions for storing trust information for a plurality of users, wherein each user has an associated level of trust with one or more other users in the plurality of users. The one or more programs include instructions for receiving, from a first user, a trust indication for a second user in the plurality of users. The one or more programs include instructions for updating the trust information of the first user based on the trust indication.

In accordance with some implementations, a method for fulfilling a recommendation request is disclosed. The method is performed on a server system having one or more processors and memory storing one or more programs for execution by the one or more processors. The server system receives a recommendation request from a first user of a plurality of users. In some implementations, the server system identifies a trust graph associated with the first user. The server system also, based on the trust graph associated with the first user, identifies one or more users trusted by the first user. In some implementations, the server system ranks the one or more identified users based on the determined level of trust. In some implementations, the server system identifies one or more potential recommenders from the one or more identified users based on the ranking. The server system sends a request for recommendations to the identified group of potential recommenders.

In accordance with some implementations, a server system for fulfilling a recommendation request is disclosed. The server system has one or more processors, and memory storing one or more programs to be executed by the one or more processors. The one or more programs include instructions for receiving a recommendation request from a first user of a plurality of users. In some implementations, the server system includes instructions for identifying a trust graph associated with the first user. The server system also includes instructions for, based on the trust graph associated with the first user, identifying one or more users trusted by the first user. In some implementations, the server system also includes instructions for ranking the one or more identified users based on the determined level of trust. In some implementations, the server system further includes instructions for identifying one or more potential recommenders from the one or more identified users based on the ranking. The server system further includes instructions for sending a request for recommendations to the identified group of potential recommenders.

In accordance with some implementations, a non-transitory computer readable storage medium storing one or more programs configured for execution by a client system is disclosed. The one or more programs also include instructions for fulfilling a recommendation request. The one or more programs further include instructions for receiving a recommendation request from a first user of a plurality of users. In some implementations, the one or more programs include instructions for identifying a trust graph associated with the first user. The one or more programs also include instructions for, based on the trust graph associated with the first user, identifying one or more users trusted by the first user. In some implementations, the one or more programs also include instructions for ranking the one or more identified users based on the determined level of trust. In some implementations, the one or more programs also include instructions for identifying one or more potential recommenders from the one or more identified users based on the ranking. The one or more programs also include instructions for sending a request for recommendations to the identified group of potential recommenders.

### BRIEF DESCRIPTION OF THE DRAWINGS

FIG. 1 is a block diagram illustrating a client-server environment in accordance with some implementations.

FIG. 2 is a block diagram illustrating a client system in accordance with some implementations.

FIG. 3 is a block diagram illustrating a server system in accordance with some implementations.

FIG. 4 depicts a block diagram of an exemplary data structure for a recommendation request 112 for requesting a recommendation from the server system.

FIG. 5 depicts a block diagram of an exemplary data structure for a trust indication that is sent to the server system to build a trust graph for each user.

FIG. 6 depicts a block diagram of an exemplary trust graph associated with a user.

FIG. 7 depicts a block diagram of an exemplary hierarchical taxonomy of trust categories for recording the trust a first user has for a second user in accordance with some implementations.

FIG. 8 is a flow diagram illustrating the process for storing levels of trust between users for use in accordance with some implementations.

FIG. 9 is a flow diagram illustrating the process for fulfilling a recommendation request in accordance with some implementations.

FIG. 10 is a flow diagram illustrating the process for fulfilling a recommendation request in accordance with some implementations.

FIG. 11 depicts an exemplary user interface in accordance with some implementations.

Like reference numerals refer to corresponding parts throughout the drawings.

### DESCRIPTION OF IMPLEMENTATIONS

In some implementations, a server system for improving the reliability of an Internet based commerce service through social network based product recommendations using a trust graph. A trust graph represents trust between users. The server system maintains a record of the trust relationships for each user registered with the service provided by the server system. In some implementations, the server system then uses this information to identify the most trusted users in at least one area of a particular user's trust graph.

In some implementations the server system receives a trust indication from a first user. The trust indication includes information identifying a second user of the plurality of users registered with the server system and a trust level that represents the level of trust that the first user has for the second user. In some implementations the trust graph is a directed graph, such that a particular trust indication only indicates the level of trust that the first user has for the second user and not the level of trust between the second user and the first user. As the first user sends more trust indications to the server, the directed trust graph of the first user includes trust information and becomes more useful. For example, a first user Bob sends three trust indications to the server system, indicating Joe, Phil, and Deborah respectively, each with a high trust level. The server system will then store these trust indications in a directed trust graph for Bob. Because the trust graph is directed, the server system does not infer trust levels for Joe, Phil, and Deborah toward Bob based on Bob's trust level towards them.

In some implementations, trust level is represented by a numerical value between 0 and 1, with 0 indicating no trust and 1 indicating maximum trust. in other implementations, the trust level is represented by a numerical value between −1 and 1, wherein 1 indicates maximum trust, −1 indicates maximum distrust, and 0 indicates no current trust information. For example, if Jim totally trusts his friend Pam, he would indicate a trust level of 1. For Jim's friend Andy, who he trusts, but not as much as Pam, Jim would indicate a trust level score between 0 and 1, such as 0.5. Further, for a distrusted person, such as Dwight, Jim would indicate a score below 0 but above −1, such as −0.5.

In accordance with some implementations, the server system can infer trust information by identifying actions taken by a particular user and determining the trust level indicated by the identified actions. For example, if the server system determines that Jim has received a recommendation for a pair of shoes from Andy, the server system can measure Jim's response to determine a trust level between Andy and Jim. If Jim purchases the recommended pair of shoes, the system will determine an increased level of trust from Jim to Andy. If Jim takes no action based on the recommendation the trust level will either remain unchanged or, if a pattern of ignoring recommendations from Andy is detected, slightly the level of trust from Jim and Andy.

In some implementations, each user of the system has a “trustworthiness” score. The trustworthiness score represents an overall rating of the quality and usefulness of that user's recommendations. In some implementations the trustworthiness score is represented by a number between 0 and 1. In other implementations, the trust worthiness score is a value with a lower bound of 0, but no upper bound. In yet other implementations, the trustworthiness score could have a negative value. In this case, a respective user's trustworthiness score increases in response to indications that the respective user's recommendations are good. For example, as users of the system chose to buy a product or service in response to a recommendation from a particular user, the trustworthiness score for the particular user would increase. Correspondingly, recommendations that are ignored or explicitly rejected could result in either no change of trustworthiness score or in a lowered trustworthiness score.

In some implementations a higher trustworthiness score represents a higher level of trustworthiness within the system. In some implementations, if a user's trustworthiness score exceeds a predetermined level the user will be noted as a tastemaker or a very influential user.

In some implementations, trust levels can be transitive between users. For example, if Jim trusts Pam with a trust level of 1 and Pam trusts Michael with a score of 0.75, the server system can calculate a trust level from Jim to Michael. In some implementations the server system calculates transitive trust by taking the trust level from Pam to Michael and discounting it by some fixed amount. For example, the trust level may be reduced by 5% for each level of removal from Jim. So Jim's trust level for Michael would be 0.75*0.95=0.7125. In some implementations, transitive trust values are calculated before any specific need for those calculated values arrives. In other implementations, only direct trust values are stored in the trust graphs and transitive trust values are only calculated when required, such as when a request for a recommendation is received by the server system.

In some implementations transitive trust is calculated through multiple users. For example, User A trusts User B, User B trusts User C, and User C trusts User D. Transitive trust can be calculated for both Users C and D, and additionally for any users trusted by Users B, C, and D. In some implementations transitive trust is calculated for as many other users and through as many connections as possible. In other implementations, the server system limits the number of connections through which an implicit trust calculation is made. By limiting the number of connections (for example, no more than 10 connections) the server system avoids using resources on very tenuous connections.

In some implementations the transitive trust calculations result in more than one possible value of transitive trust from first user to a second user. For example, if user A trusts Users B and C, and both Users B and C trust User D, the value of the implicit trust calculation will depend on whether the connection is made through user B or user C. In some implementations all possible trust levels are averaged to determine the actual implicit trust level. In other implementations the server system selects either the highest or lowest trust level. In yet other implementations, the server system selects the implicit trust value that relies on the fewest number of connections. If multiple implicit trust values are tied for the fewest number of connections, the multiple trust values are averaged.

In some implementations, an aggregate trust value is calculated for multiple trust paths by using a probabilistic combination algorithm. Such an algorithm is AggregateTrustLevel=1−(1-p_{—}1)*(1-p_{—}2)* . . . (1-p_n) where p_{—}1-p_n are trust levels from a plurality of different possible trust paths. For example if one path gives a trust value of 0.8 and another gives a trust value of 0.63, the aggregate trust level would equal 1−(1−0.8)*(1−0.63)=0.926. This function can be used for an arbitrary number of different trust paths.

In some implementations a trust indication from a first user to a second user indicates a specific category in which the indicated trust level applies. For example, Bob could trust Alice at a high level in one category of product, such as consumer electronics, but trust Alice at a low level for a second type of product, such as men's shoes. Thus, when the first user submits a trust indication of a trust level for the second user, the trust indication includes the category of product or service for which the trust level applies. In this way the trust graph can include different trust levels for different categories of products. In some implementations, the different categories are arranged in a hierarchical format. In some arrangement the highest hierarchical level is a general level and there are a plurality of sub levels underneath the top general level such as “fashion,” “electronics,” and “media” among others. Each sublevel has more specific sub levels under them. For example, the sublevel “fashion” could include the sublevels of “women's wear,” “men's wear” and “kid's wear.”

In some implementations, the server system can propagate trust levels from a sub-level to hierarchical levels higher, more general categories in the hierarchy of categories and to lower, more specific categories in the hierarchy of categories. In some implementations, trust scores are passed to lower, more specific categories without alteration, but trust levels are discounted when passed to higher, more general categories in the hierarchy. For example, Jim trusts Andy 0.5 in the category “Shoes.” That score is propagated to lower, more specific categories, such as “Athletic shoes” or “Formal Shoes”, without discount. However, when the trust level is propagated to higher, more general category, such as “Fashion,” the trust level is discounted by 10%. Thus, the graph would determine that Jim trusts Andy in “Fashion” at the level of 0.45.

In some implementations, the server system uses the gathered trust information to improve a user's experience. The server system allows users to request recommendations for goods and services that the user is interested in purchasing. The server system uses the stored trust graphs to identify trusted potential recommenders. The server system first receives a request for a recommendation from a first user. The request for recommendation includes a category of good or service that defines the type of recommendation the first user wants. The server system uses the trust graph associated with the first user, among other factors, to determine a second user from whom to request a recommendation.

In some implementations, when a user first registers with the server system to participate in the online commerce system, the user has little or no trust information regarding other users. The server system can collect user information from other social networks (Facebook, Twitter, LinkedIn, etc) or from webmail address books to identify other users of the server system that the new user might wish to trust. The server system then displays trust recommendations to the user. In some implementations, the server system only accesses the other social network information with the express permission of the user. In some implementations, the server system can gather demographic information from the new user and uses that demographic information (for example, user age and location) to determine recommended products and other users the potential new unit may wish to trust.

In some implementations, the server system uses the social network and demographic information gathered from external sources, as described above, to determine recommendations from the user's social network prior to receiving adequate trust level information from the user. In some implementations, the server system uses general product popularity data to find recommendations for users without sufficient trust information. General product popularity data is data that describes how popular particular products are within their product category. In other implementations, the server system uses direct editorial control (an editor selecting specific recommendations) to supply recommendations prior to receiving adequate trust level information from the user.

In some implementations, the server system will identify one or more users not already trusted by a first user (User A) that the server system has determined are likely to be trusted by the first user. In some implementations the server system identifies the one or more users by finding connections or similarities between the one or more users and the first user. For example, if multiple users trusted by the first user all trust a second user the server system determines that the first user will be likely to trust the second user. In other implementations, the server system will identify one or more users that have similar identified interests as the first user or have recommended similar products to those recommended by the first user. In yet other implementations, the server system identifies one or more users likely to be trusted by the first user using social connection information from third party websites or services, interactions that the users have had with the server system, and any other information the server system has with regard to the users.

In some implementations, the server system identifies a particular category in which the first user is likely to trust the one or more users. In some implementations, the server system identifies one or more users likely to be trusted by the first user in response to a request from the first user for recommendations of users to trust. In some implementations, the server system transmits the identified one or more users to the first user for display. In some implementation the server system also transmits information describing the reasons why the server system selected a particular user that can be displayed either with the recommendation itself or at the request of the first user. For example, the server system transmits a recommendation for Bob to trust Ernie and includes the fact that Ernie was identified because three people trusted by Bob (Alice, Carol, and Dan) also trust Ernie.

In some implementations, the one or more identified users are recommended only in a particular category. In response to receiving a recommendation to trust a second user in a specific category, the first user can choose to trust the user only in the recommended category, trust the user in a narrower category than the recommended category, or trust the user in a broader category than the recommended category. For example, the server system recommends that Bob trust Ernie in Men's Formal Clothes. Bob has the option of trusting Ernie in only Men's Formal Clothes, in a narrow category such as Men's Belts, or a broader category such as all Menswear. In some implementation, the first user can request to view public information about the identified on or more users in determining whether to trust the user or not. In some implementations, the first user can only see information that the identified one or more users have explicitly marked as public. For example, Ernie may have made his recommendations in Menswear public, and Bob can view the recommendations as part of his decision whether or not to trust Ernie.

In accordance with some implementations in response to receiving a request for a recommendation, the server system determines a list of users in the first user's trust graph that have trust scores in the category requested by the user. The determined list has one or more other users. The server system then ranks the one or more users in order of trust level. In some implementations, the client system calculates transitive trust values for users with whom the first user does not have a direct trust level and includes at least some of these users in the list. Transitive trust values may also be pre-calculated and stored in the server system. When a server system receives a request for a recommendation, the server system determines whether additional transitive trust values need to be calculated. In some implementations, only some transitive trust values are pre-calculated and others are calculated as needed. For example, only first-order transitive trust values are pre-calculated and all other transitive trust values are calculated as needed. First order transitive trust values that only have one indirect trust link. For example, if Bob directly trusts Alice and Cody, then the first order transitive trust values are calculated for the users directly trusted by Alice and Cody.

In some implementations, the server system also includes users who are designated as highly influential users over the entire system for the requested category. For example, if Bob is highly trusted by a significant portion of registered users and has a high number of successful recommendations, Bob may be designated as a highly influential user in a specific category.

In some implementations, the server system then selects a number of users included on the list. In some implementations, this number is a predetermined number, such as 3. In other implementations, this number includes all the users above a certain trust level. In yet other implementations, this number is a variable number depending on a variety of factors, such as the number of recommendations already requested and the number of previous recommendations that have been accepted. For example, the server system orders 20 users from highest to lowest trust. The server system then determines the 3 most highly trusted users that have not had a recommendation request within the last two days. In this way the server system avoids flooding users with too many requests for recommendation.

In some implementations the server system sends a message to the selected users, requesting a recommendation in the selected category. The message can be sent over any communication medium available to the user, including, but not limited to, email, text message, twitter, voicemail, or a messaging service internal to the server system. The server system then waits a predetermined amount of time. In some implementations, the predetermined amount of time is standard across the entire system. In other implementations, the predetermined amount of time is determined in accordance with urgency characteristics of the request.

In some implementations, when submitting a request, the first user indicates a time frame in which the first user wants the request for a recommendation to be fulfilled. The server system selects a predetermined amount of time such that any recommendations will be received before the end of the indicated time frame. For example, the first user emails a request for a recommendation for a smart phone to the server system and indicates he would like a recommendation within 24 hours. The server system would then determine an appropriate period of time, such as 8 hours, to wait for recommendations and if none were received, it would take action to ensure that recommendations are received.

In accordance with some implementations, when the predetermined amount of time has passed, the server determines whether any recommendations have been returned. Users return recommendations to the server system through any communication method available to the user. For example, if the request for a recommendation is sent to the user through his email service, the user may reply directly to the email or choose another communication method, such as a text or voice message, to return a recommendation. The server system maintains a list of any pending requests for recommendations for each user. When a user logs onto the server system, the server system notifies the user whether there are any pending requests for recommendations. In some implementations, the user can submit recommendations through the server system interface itself. The server system then rewards users who submit recommendations in response to requests for recommendation within the predetermined time.

In some implementations, if one or more recommendations have been received from recommending users, the server system selects at least one of the recommendations to forward to the requesting first user. In some implementations, the server system selects the recommendation from the user with the highest trust value. In other implementations, the server system selects at least one recommendation to send to the requesting first user based on a number factors, including but not limited to, the overall popularity of the recommended items, the recommendation history of the recommending user, the brand preferences of the requesting user, and the price preferences of the requesting user. In some implementations the server system requests a large number of recommendations in response to a request (more than would normally be needed to fulfill a request for recommendations) and uses the extra recommendations to build a larger database of user recommendations.

In some implementation, after the predetermined amount of time, the server system determines that none of the selected users have responded to the requests for recommendations. In accordance with a determination that no users have yet responded to the request for recommendations, the server system selects additional users to whom it sends a request for a recommendation. Additional requests can then be sent out before the predetermined amount of time has expired.

In some implementations, the server system identifies a list of previously received recommendations in the requested category. The server system then ranks the list of previously received recommendations based on a number of factors, including, but not limited to the trust level the requesting first user has for the user who submitted the recommendation, the brand and price preferences of the user, the overall popularity of the item, how long ago the recommendation was made, and how other users have responded to the recommendation. So for example, if after 4 hours no recommendations have been received from the users who had been contacted by the server system, the server system can either choose another set of potential recommenders and/or review previously recommended items in the relevant category for appropriate recommendations for the user. In this way, the system can guarantee recommendations within the time frame requested by the user.

In accordance with some implementations, the server system sends one or more recommendations to the requesting first user. The first user may then respond to the recommendation with a purchasing intent indication. In response to receiving a purchase intent indication from the first user, the server system purchases the recommended product on behalf of the first user. In some implementations, the server system does not purchase the product or service on behalf of a user. Instead the server system arranges a product purchase and sends the user a link to easily purchase the good or service themselves. In other implementations, employees associated with the server system manually purchase the product or service and arrange for delivery to the user. In some implementations, the server system monitors the first user's purchasing decisions. When the first user purchases a recommended product, the server system responds by increasing the trust level between the first user and the user who supplied the recommendation. For example, Bob recommends a particular smart phone to Alice. If Alice buys the smart phone based on Bob's recommendation, the server system will increase the trust level from Alice to Bob. As noted above, in some implementations, Alice's trust level for Bob will not be increased but Bob's overall trustworthiness score is increased.

In some implementations, the user can rate the purchased product. If a user rating of a purchased product is identified, the server system can then use that information to update trust information. For example, if Alice submits a good review of the smart phone she purchased, the server system will both update Alice's product preferences and also increase her trust level for the user who recommended the smart phone. However, if Alice submits a bad review for the smart phone she purchased, the system will then decrease her trust level for the user who submitted the recommendation.

In some implementations, the user that supplied the recommendation is rewarded by the server system and the overall influence ranking of the user increases for the category of the recommended product. For example, Jim requests recommendations for a new laptop. The server system determines the top 10 potential recommenders and sends them each an email notifying them of the requested recommendation. Dwight, Pam, and Michael all respond with laptop recommendations. Of the three recommendations, the server system selects both Pam's and Dwight's recommendations as being the most relevant and forwards those recommendations to Jim. Jim responds by indicating he would like to purchase the laptop recommended by Dwight. As a result, the server system increase Jim's trust level for Dwight in the category of laptops and increases Dwight's total influence score in that category as well. In some implementations, Dwight also receives a reward from the server system itself. In some implementations, a recommender receives a reward from the merchant who sold the item.

In some implementations the server system prepares recommendations for users without a direct request from the user. When the user interacts with the service provided by the server system, such as visiting the webpage associated with the server system, the server system presents one or more recommendations to the user. In some implementations the server system first determines one or more categories of most interest to the user visiting the web page. The server system determines categories of interest to the user by information stored in the user's profile concerning, among other things buying patterns, recent requests, searches, viewing history, brand preferences, time and date information, information stored about the other users connected to the first user, prior product reviews by the user, prior professional reviews by third parties, and overall trends within the community associated with the server system. For example, if a user has recently been searching for “iPhone 4GS” and “Samsung Galaxy 3,” and a friend whom he trusts has recently purchased a “Nokia Lumia 920,” the server system will determine that the user is interested in the category “Smart phone.”

In accordance with some implementations, the server system determines recommendations for the one or more categories determined to be of most interest to the user visiting the webpage. For each category determined to be of most interest to the user, the server system identifies all the recommendations for that category in the trust graph of the user. The server system then ranks the identified recommendations based on the trust level associated with the maker of the recommendation, the preferences of the user, the popularity of the product, and opinions of highly influential users, among other criteria.

In some implementations, the server system determines a list of recommendations that match a particular category. The server system retrieves this list from a database of stored recommendations. Once the list has been retrieved, the server system ranks the list of potential recommendations in accordance with trust information stored in the trust graph. In some implementations, the potential recommendations are also ranked in accordance with other factors, such as overall product popularity, price, and user preferences.

In some implementations, the server system then displays the recommendations to the user in ranked order from most relevant to least relevant. In some implementations, the displayed recommendations are ranked in accordance with other factors, such as price or product popularity. In some implementations, the server system also displays pictures or symbols representing the recommending users on or near the images representing the recommended items. In some implementations, a first user of the server system can request a description of the recommendation source (a description of why the server system has delivered a specific recommendation to the first user.) In some implementations, a recommendation from the server system is from a second user directly trusted by the first user. When the first user requests a description of the recommendation source, the server system displays the second user as the source. For example, if Jake trusts Alan and receives a recommendation of a pair of shoes recommended by Alan, the description of the recommendation score would include the name of Alan and the fact that Jake directly trusts Alan.

In some implementations, a recommendation is from a second user not directly trusted by the first user, but for whom the server system has calculated an implicit trust level. When the user requests a description of the recommendation source, the server system displays the implicit trust chain. An implicit trust chain is a representation of the connections necessary to generate the implicit trust level. For example, User A directly trusts User B. User B directly trusts User C and User C trusts User D. The implicit trust chain from A to D would be A→B→C→D. Thus, when a user requests a recommendation source, the server system displays the associated implicit trust chain. In some implementations more than one possible implicit trust chain exists (more than one path from A to D) and the server displays the shortest implicit trust chain.

In some implementations, the server system only displays a portion of the total implicit trust chain. For example, if the implicit trust chain is so, long that it cannot easily be displayed the server system displays only the first and last few connections in the implicit trust chain. In some implementations, the server system displays only the first connection in the implicit trust chain (the person that the first user trusts directly) and then a numeric representation of the number of connections in the chain. For example, if user Frank receives a recommendation that is the result of a 10 person implicit trust chain that starts with user John, the system can display all 10 connections, display the first two and last two connections in the chain, or only the identify of John, the first link in the chain.

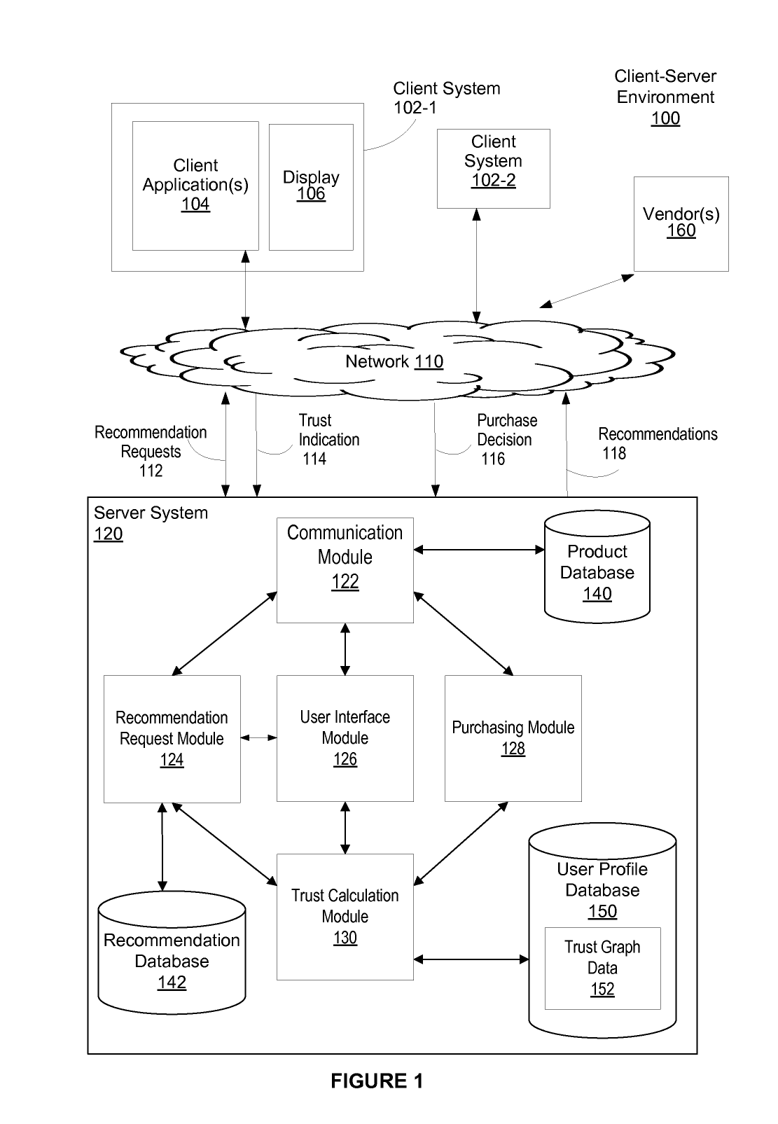

FIG. 1 is a block diagram illustrating a client-server environment 100 in accordance with some implementations. The client-server environment 100 includes one or more client systems 102-1 and 102-2, a server system 120, and one or more vendors 112, all connected over a network 110. In some implementations, the client system 102 includes one or more client applications 104 and a display 106. The server system 120 includes a communication module 122, a recommendation request module 124, a user interface module 126, a purchasing module 128, and a trust calculation module 130, a product database 140, a recommendation database 142, and a user profile database 150. The network 110 may be any of a variety of networks, including local area networks (LAN), wide area networks (WAN), wireless networks, wired networks, the Internet, or a combination of such networks.

In accordance with some implementations, the client system 102 includes one or more client applications 104. The one or more client applications 104 include, but are not limited to, a web browsing application for connecting to the server system 120. The client system also includes a display 106. In some implementations, the display is integrated directly into the client device, such as laptops, smart phones, and tablet computers. In other implementations the device is connected to, but not integrated into the client system. For example, personal computer systems typically do not have an integrated display and instead connect to a standalone display either wirelessly or otherwise.

In some implementations, the client system 102 sends a trust indication 114 to the server system 120. The trust indication 114 indicates a first user of the plurality of users registered with the server system 120, a second user of the plurality of users registered with the server system 120, and a trust level from the first user to the second. In some implementations the indicated trust level is represented by a numerical value between 0 and 1, with 0 indicating no trust and 1 indicating maximum trust. In other implementations, the trust level is represented by a numerical value between −1 and 1, wherein 1 indicates maximum trust, −1 indicates maximum distrust, and 0 indicates no current trust information. For example, the client system 102 calls a function such as Trust(A, B) which establishes trust from user A to user B. A more sophisticated trust function would include the product category and would be invoked by calling Trust(A, B, Category) to establish a trust from user A to user B with regards to a give Category. In some implementations, user functions are unique to each user and include a trust level. For example a trust function associated with user A and including a trust level would be Trust_A(B, “Shoes”, 0.5). The server system 120 uses the received trust indication 114 to build a trust graph associated with the first user of the plurality of users.

In some implementations, the client system 102 sends the server system a request for a product recommendation 112. A request for recommendation 112 is from a first user associated with the client system 102 and indicates a category of good or service for which the first user would like a recommendation. In some implementations, the server system 120 uses trust information stored in the first user's trust graph to identify one or more potential recommenders from the plurality of users associated with the server system 120. In some implementations, the server system 120 sends requests to the client system 102-2 of a second user registered with the server system 120 for appropriate recommendations in response to the request. The second client system 102-2 associated with the second user receives the server system's 120 request for appropriate recommendations 112.

In some implementations, the second user responds to the request for recommendations by selecting a good or service to recommend. The second client system 102-2 associated with the second user then transmits the recommendation 118 to the server system 120. The product recommendation 118 sent from the second client system 102-2 to the server system 120 is a recommendation for a product in the same category as originally requested by the first user. The server system 120 receives one or more product recommendations 118 and determines one or more recommendations 118 to send to the first user.

In some implementations the client system 102 receives one or more product recommendations 118 from the server system 120. The client system 120 displays the one or more product recommendations 118 to the first user. In some implementations, when the first user selects one of the displayed recommendations 188, the client system 102-1 transmits a purchase decision 116 to the server system 120.

In accordance with some implementations, the server system 120 includes a communication module 122, a recommendation request module 124, a user interface module 126, a purchasing module 128, a trust calculation module 130, a product database 140, a recommendation database 142, and a user profile database 150. The communication module is configured to send and receive communication over the network 110 to one or more client systems 102 and one or more vendors 160.

In accordance with some implementations the recommendation request module 124 is configured to receive a recommendation request 112 from a client system. The recommendation request 112 includes information identifying the first user requesting the recommendation, the category of product or service for which the recommendation is desired, a time frame for receiving a recommendation, a price range for the recommended product, the number of desired recommendations, and any other parameters specified by the first user. The recommendation request module 124 uses the data included in the recommendation request 112 to determine a list of one or more potential recommenders from the plurality of users.

In some implementations, the recommendation request module 124 determines a list of potential recommenders by analyzing the trust graph of the requesting first user to identify users whom the first user trusts in the requested category. The list of potential recommenders includes a determined number of recommenders. In some implementations, the number of determined potential recommenders is predetermined by the server system 120. In other implementations, the number of potential recommenders is determined by the request 112 of the requesting first user. In yet other implementations, the number of potential recommenders is determined dynamically based on the number of suitable candidates, the number of requests for recommendation 112 received from the particular requestor, and the category of product requested.

In some implementations, the recommendation request module 124 identifies the users directly trusted by the first requesting user and selects the users most highly trusted, either generally or in the specific category requested. If there are not enough directly trusted users identified the recommendation request module 124 then requests that the trust calculation module 130 calculate indirect trust with users for whom the first user may have transitive trust or conveyed trust. Transitive trust is determined by inferring at least some trust on the part of a first user based on the trust relationships of the users trusted by the first user. Transitive trust is discussed in more detail below.

In some implementations the directly trusted users and the indirectly trusted users may be insufficient to reach the number of potential recommenders required. In some implementations the recommendation request module 124 also includes users who are “highly influential” in the requested category. In some implementations the server system 120 removes users from the list of potential recommenders to avoid flooding certain users with an unreasonable amount of communications traffic from the server system 120. By limiting the number of communications to any particular user, the server system 120 avoids flooding or burning out the user. In some implementations, users are able to determine the frequency at which they receive requests for recommendations. For example, a user can establish that they will receive no more than 2 recommendations per month.

In some implementations, the recommendation request module 122 employs the communication module 124 to send a request 112 to each user in the identified list of potential recommenders. The communication module 122 then receives recommendations from one or more client systems 120 associated with one or more users in the identified list of potential recommenders. The recommendation request module 122 then selects one or more of the received recommendations to send to the client system 102 associated with the first requesting user.

In some implementations, the user interface module 126 is configured to arrange a web page associated with the server system 120 such that, when requested by a client system 102 associated with a user, the web page includes recommendations customized to the requesting user. The user interface module 126 determines categories of interest to the user based on the user's profile, previous purchases, search history, viewing history, prior product reviews, prior product recommendations, and user profiles of users they trust, among other factors. The user interface module 126 then determines recommendations for a respective category in the determined categories by identifying users trusted by the first user in the respective categories who have recommendations in those categories. In some implementations, the determined recommendations are combined with traditional search results. Any method of searching products in response to a search query can be used to produce traditional search results.

In some implementations, the user interface module 126 then ranks the recommendations by the trust level the first user has with the recommending user (either direct or indirect trust), the overall popularity of the product recommended, the amount of time passed since the time the recommendation was made, professional reviews, prior purchasing decisions, prior product reviews, prior recommendations, and other factors included in the requesting user's profile, such as price, size, color, materials, features, and brand. The user interface module 126 configures the web page to display categories in order of determined interest to the first user, with higher categories being of more interest than lower categories.

In some implementations the user interface module 126 orders recommendations within a particular category on the web page by the predicted interest of the user such that the higher a product is ranked in accordance with the predicted interest of the user, the sooner the recommendation is displayed. In some implementations, products receive a ranking score based on predicted interest of the user and ordered based on the ranking score. In some implementations the user interface module 126 configures the web page to display the recommendations as an image of the recommended product. In some implementations the user interface module 126 includes an image of the recommender on top of or near the image of the recommended product.

In some implementations, the purchasing module 128 is configured to receive a purchasing decision message 116 from a client system 102. Based on this message, the purchasing module 128 determines the product to be purchased and identifies the relevant vendor in the products database 140. The purchasing module 128 then enlists the communication module 122 to purchase the desired product from one of the vendors 160 available over the network 110.

In some implementations, the trust calculation module 130 is configured to build and maintain trust graphs for each user registered with the server system 120. In some implementations, the trust calculation module 130 receives a trust indication 114 from a client system 102 associated with a first user. The trust indication 114 includes information identifying the first user, a second user, and a trust level from the first user to the second user. As noted above, the trust level is a numeric value indicating the level of trust between the two users. The trust calculation module 130 builds trust graphs by collecting a plurality of trust indications 114 for each user registered with the server system 120.

In some implementations, the trust calculation module 130 updates a user's trust graph based on the user's interactions with the server system 120, interactions with others, and purchasing decisions. For example, if a first user buys a product that has been recommended by another user, the trust calculation module 130 will infer that the first user trusts the recommending user and will increase the trust level to reflect the inference of greater trust.

In some implementations, the product database 140 contains information for products that may be purchased through the server system 120. In some implementations the products in the product database 140 are added by partner vendors 160. In some implementations the products in the database 140 are added by users and recommenders in the server system 120. The products database 240 includes information for each product, including, but not limited to, the price of the product, its specification (size, color, etc), and the vendor or vendors from which it is available. In some implementations, the client system 102 sends a purchase decision 116 to the server system 120 and the purchasing module uses the information stored in the product database 140 to purchase the selected product.

In some implementations, the recommendation database 142 stores recommendations received from users of the server system 120. In some implementations, the recommendation database maintains a list of all recommendations ever made by any users of the database, how successful those recommendations were (what percentage of users purchased the recommended product when give this recommendation), and information concerning the request for recommendation that prompted the recommendation. In other implementations, only a portion of the total recommendations are retained in the recommendation database 142 at any given time, based on how long ago the recommendation was made, whether the product is still available, the trustworthiness of the recommending user, how popular the recommendation has been, etc.

In some implementations, the recommendation request module 124 receives a request for recommendations 112 from a user. In response, the recommendation request module 124 queries the recommendation database for any stored recommendations that meet the requested criteria. The recommendation database 142 then returns a list of potential recommendations to the recommendation request module 124. The recommendation request module then orders the potential recommendations by the trust level of the requesting user for the recommending user. The server system (FIG. 1, 120) then selects a predetermined number of recommendations from top of the ordered list and displays the selected recommendations to the requesting user.

In some implementations the user profile database 150 contains user profiles for users who have registered to use the service provided by the server system 120. In some implementations, a user profile includes the name, ID, demographic information (gender, age, location, etc), purchasing history, social network information, and trust information. The user profile database 150 includes trust graph data 152. In some implementations, the trust graph database includes information describing a directed trust graph. The trust graph includes nodes, which represent users, and edges connecting nodes, which represent the trust level between the two users represented by the two nodes that the edge connects.

In some implementations, the vendors 160 are commercial organizations with products to sell. The vendors 160 can receive orders to purchase products from the server system 120 and fulfill those orders.

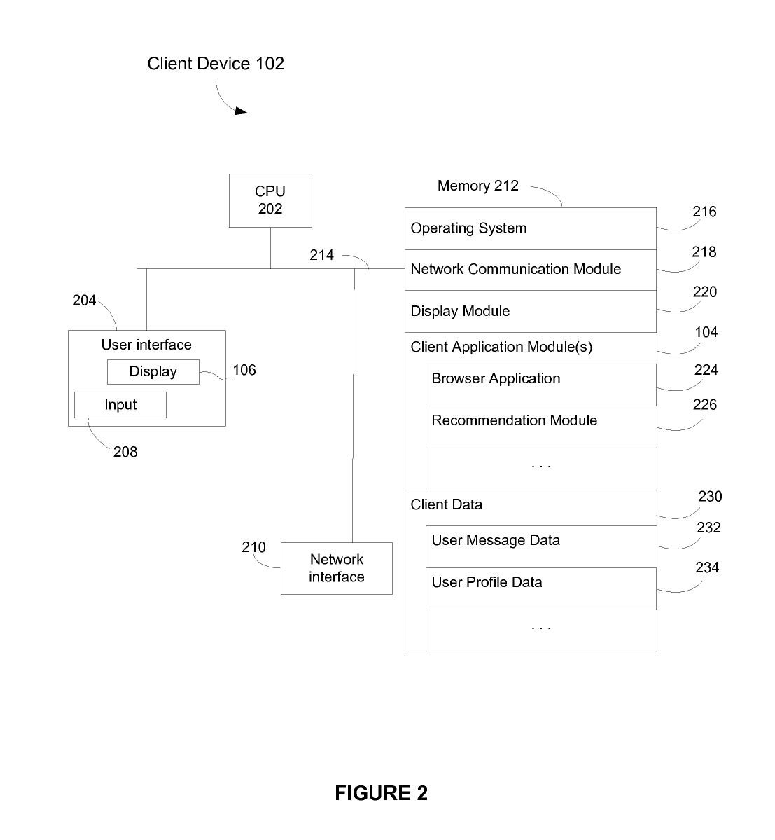

FIG. 2 is a block diagram illustrating a client system 102, in accordance with some implementations. The client system 102 typically includes one or more processing units (CPU's) 202, one or more network interfaces 210, memory 212, and one or more communication buses 214 for interconnecting these components. The client system 102 includes a user interface 204. The user interface 204 includes an associated display device 104 and optionally includes an input means such as a keyboard, mouse, a touch sensitive display, or other input buttons 208. Optionally, the display device 106 includes an audio device or other information delivery device. Furthermore, some client systems use a microphone and voice recognition to supplement or replace the keyboard.

Memory 212 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 212 may optionally include one or more storage devices remotely located from the CPU(s) 202. Memory 212, or alternately the non-volatile memory device(s) within memory 212, includes a non-transitory computer readable storage medium. In some implementations, memory 212 or the computer readable storage medium of memory 212 stores the following programs, modules and data structures, or a subset thereof:
an operating system 216 that includes procedures for handling various basic system services and for performing hardware dependent tasks;
a network communication module 218 that is used for connecting the client system 102 to other computers via the one or more communication network interfaces 210 (wired or wireless) and one or more communication networks, such as the Internet, other wide area networks, local area networks, metropolitan area networks, and so on;
a display module 220 for enabling display of media on a display 106 associated with the client system 102;
one or more client system 102 applications module(s) 104 for enabling the client system 102 to perform the functions offered by the client system 102, including but not limited to:
   a browser application 224 for sending requests to a server system (FIG. 1, 120) and displaying the information (for example web pages) returned by the server system (FIG. 1, 120) or a smart phone app that performs the same function;
   a recommendation module 226 for enabling a user to send a request for a recommendation to a server system (FIG. 1, 120), receiving a message requesting a recommendation from another user from the server system (FIG. 1, 120), and to select a good or service to recommend to another user and transmit the recommendation information to the server system (FIG. 1, 120); and
a client data 240 for storing data related to the client system 102, including but not limited to:
   client message data 232, including data representing messages to be sent to the server system (FIG. 1, 120) and messages received from the server system (FIG. 1, 120); and
   user profile data 234, including information concerning users of the client system 102 such as a user profile, user preferences and interests, and other information relevant to providing services to the user.

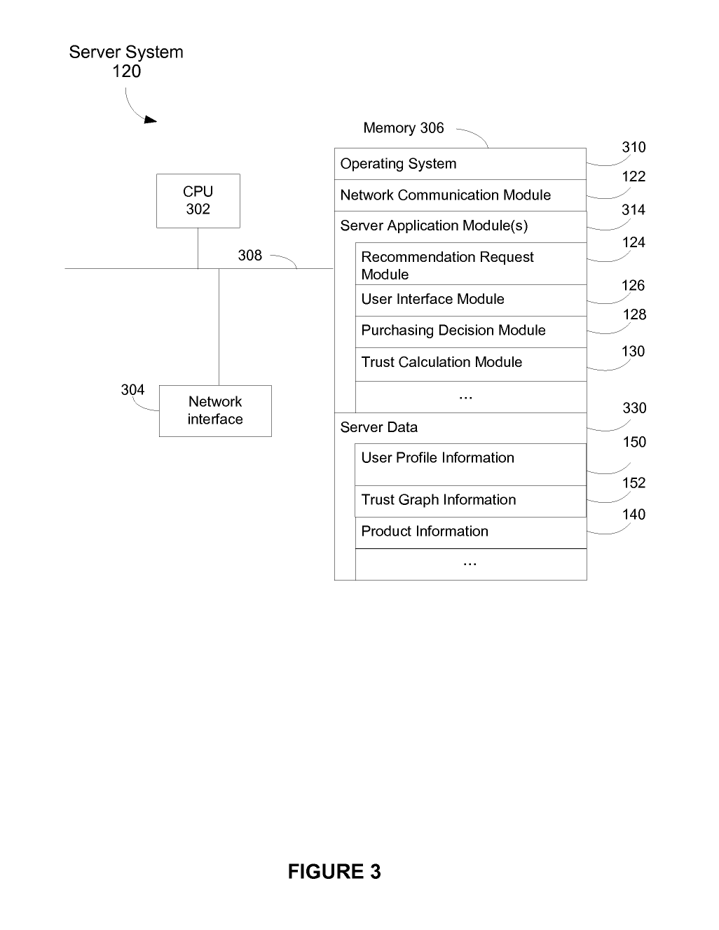

FIG. 3 is a block diagram illustrating a server system 120, in accordance with some implementations. The server system 120 typically includes one or more processing units (CPU's) 302, one or more network interfaces 304, memory 306, and one or more communication buses 308 for interconnecting these components.

Memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302. Memory 306, or alternately the non-volatile memory device(s) within memory 306, includes a non-transitory computer readable storage medium. In some implementations, memory 306 or the computer readable storage medium of memory 306 stores the following programs, modules and data structures, or a subset thereof:
an operating system 310 that includes procedures for handling various basic system services and for performing hardware dependent tasks;
a network communication module 122 that is used for connecting the server system 120 to other computers via the one or more communication network interfaces 304 (wired or wireless) and one or more communication networks, such as the Internet, other wide area networks, local area networks, metropolitan area networks, and so on;
one or more server application module(s) 314 for enabling the server system 120 to perform the functions offered by the server system 120, including but not limited to:
   a recommendation request module 124 for receiving a recommendation request from a first user, determining potential recommenders using the trust graph information associated with the first user, sending a request for recommendations to the determined potential recommenders, receiving one or more recommendations from the determined potential recommenders, and sending one or more recommendation to the first user;
   a user interface module 126 for configuring the information displayed at the client system when the client system (FIG. 1, 104) requests a web page from the server system 120;
   a purchasing decision module 128 for receiving a purchasing decision 116 from a client system (FIG. 1, 102) that indicates a user's intention to purchase a good or service through the server system and for purchasing the good or service from one of the vendors (FIG. 1, 160); and
   a trust calculation module 130 for storing trust indications received from client systems (FIG. 1, 102), using the stored trust indications to build a directed trust graph, and identifying the trust level between two users based on the stored trust data; and
one or more server data module(s) 330 for storing data related to the server system 120, including but not limited to:
   user profile information database 150 including user preferences and interests, user history, including past user purchases, searches, page views, previously product recommendations, previous product reviews, and social connections of the user;
   trust graph information 152 including information describing trust between users of the server system 120 including data indicating the categories in which users trust each other; and
   product information 140 including information contains information for products that may be purchased through the server system 120, including, but not limited to, the price of the product, its features (size, color, etc), and the vendor or vendors from which it is available.

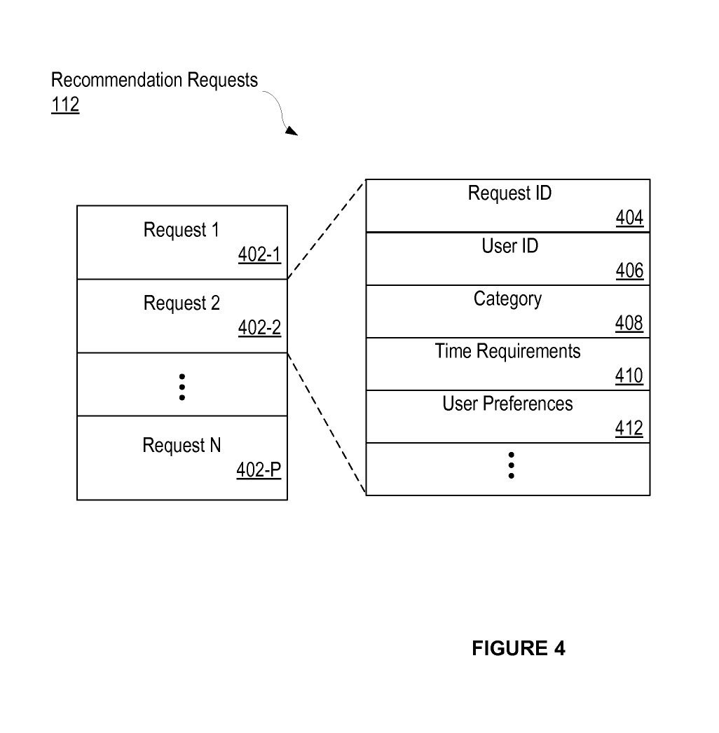

FIG. 4 depicts a block diagram of an exemplary data structure for a recommendation request 112 for requesting a recommendation from the server system (FIG. 1, 120). In accordance with some implementations, the recommendation request module 124 includes a plurality of recommendation requests 402-1 to 402-P, each of which corresponds to a user-submitted recommendation request. In some implementations, each recommendation request 114 contains a request ID 416 that identifies a particular recommendation request 404, the ID of the user submitting the request 406, the category of product requested 408, the time requirements 410 of the request, and the user preferences 412 for the product features.

In some implementations, the stored requested category information 408 includes the category of product for which the user requests a recommendation. The category information includes at least one category from the list of possible categories associated with the server system (FIG. 1, 120). For example, the category may be narrow such as Nokia brand smart phones or broad, such as men's athletic shoes.

In some implementations, the time requirements 410 describe the time parameters during which the requesting user would like a recommendation. For example, a user might request a recommendation within 24 hours. In some implementations, a recommendation request also includes user preferences 412 regarding the product recommendations. In some implementations, user preferences 412 include any criteria by which potential requests can be distinguished, including the price range specified by the user, brands or vendors favored by the user, colors, styles, size of the product, options included with the product, quantity of the product available, material used to fabricate the product, the number of units, the pattern of the product design, whether the product is local, the level of service associated with the product, whether the vender allows custom modifications, whether the vendor allows special requests of any kind, whether the product comes with a warranty, the assembly status of the product (for example, pre-assembled, partially assembled, or unassembled), the artist or maker associated with the product, the format of the product, or the version of the product, whether the price of the product has been reduced as part of a sale, whether the product has been discontinued, and any other feature or characteristic that the user desires for the requested recommendation.

In some implementations, the user preferences 412 can include preferences for delivery options such as the speed of delivery, the cost of delivery, the delivery provider, the delivery service provider, delivery insurance availability, the delivery period, white glove delivery options, in store pick-up options, method of delivery (electronic or physical), the return policy, and the pre-order policy, or any other delivery option that may be preferred by a user.

In some implementations, the user preferences 412 include gift options such as the availability to ship to multiple addresses, whether the product can be gift-wrapped, whether a gift note or card can be included, and whether a gift receipt is available. In some implementations one or more of the user preferences 412 can be mandatory features for any recommended product.

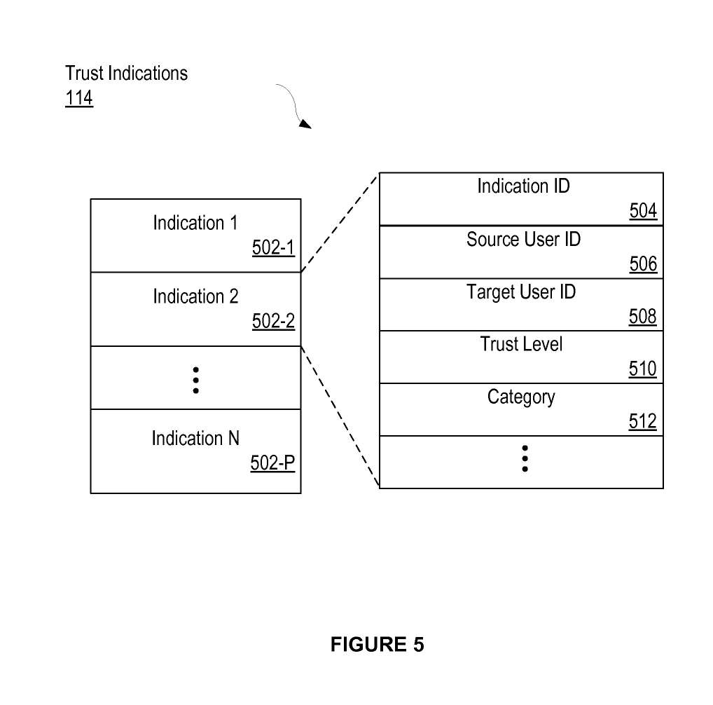

FIG. 5 depicts a block diagram of an exemplary data structure for a trust indication 114 that is sent to the server system (FIG. 1, 120) to build a trust graph for each user. In accordance with some implementations, the trust calculation module 130 includes a plurality of recommendation requests 502-1 to 452-P, each of which corresponds to a user-submitted trust indication. In some implementations, each trust indication 114 includes a indication ID that identifies a particular trust indication 504, the ID of the user submitting the indication 506, the target user ID representing the ID of the user for whom the trust indication is submitted 508, a trust level 510 representing the amount of trust from the first user to the second user 508, and the category to which the trust applies 512. For example, the first user (Alice) trusts the second user (Bob) in the category of electronic cameras. The trust indication would include Alice, Bob, a numerical representation of the level of trust Alice has for Bob, and the category of electronic camera.

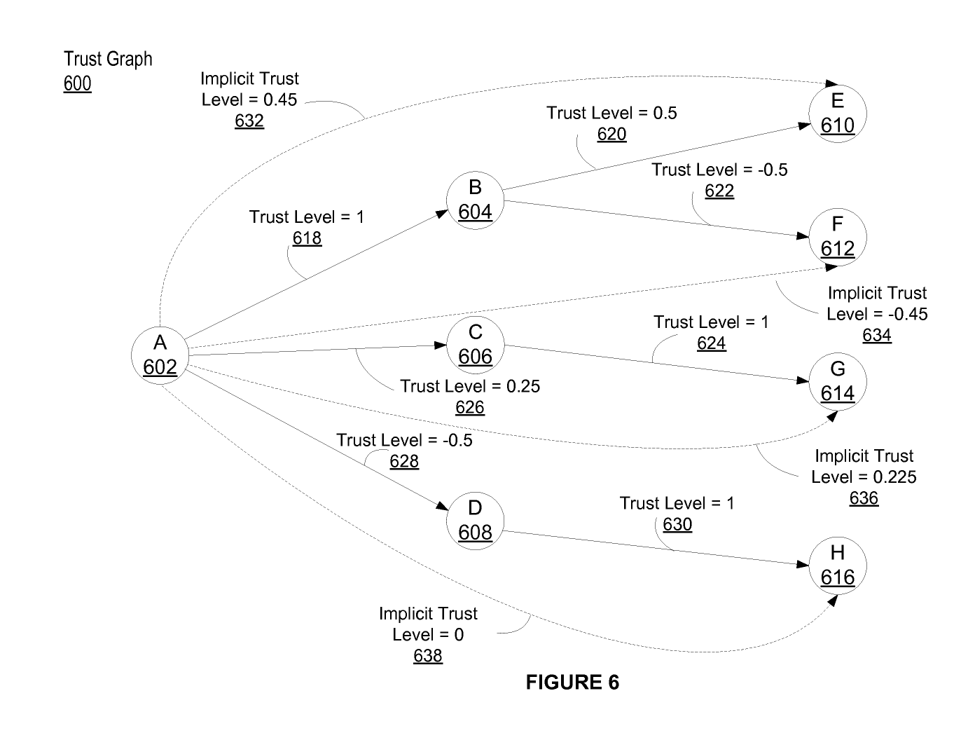

FIG. 6 depicts a block diagram of an exemplary trust graph associated with a user. In some implementations a directed trust graph for a user A 602 depicts a plurality of nodes that represents users and connections between users that represent the trust level from the first user to the second user. Because the trust graph is a directed graph, any particular trust level value only gives information as to the trust that the first user has for the second user. The trust the second user has for the first user is represented in a separate and distinct trust value from the second user to the first user. As noted above, the trust level is a numerical value that represents the trust from one user to another. In some implementations the trust level is a number between −1 and 1 where 1 represents full trust, −1 represents complete distrust, and 0 represents no trust information. In some implementations trust levels are only number between 0 and 1, with no indication of distrust.

In some implementations a trust graph displays connections between a first user A 602 and the users for whom the server system (FIG. 1, 120) has trust information (users B 604, C 606, and D 608). The trust graph includes trust levels between user A 602 and users B 604, C 606, and D 608. In some implementations the trust graph 600 includes users (E 610, F 612, G 614, and H 616) for whom the trust graph 600 has no direct trust indication from user A 602 but does have direct trust indications from users B 604, C 606, and D 608 for whom the trust graph 600 does have direct trust indications from user A. In some implementations, the trust graph 600 calculates implicit trust levels for users that user A has not trusted explicitly but who are trusted by users whom user A has trusted. In some cases the implicit trust level of A for C can be calculated by assigning the level of trust for C of some intermediate user B to A. For example if A trusts B and B trusts C, the implicit or transitive trust could be calculated such that A trusts B.

In some implementations, the trust level of A to C is a factor of the amount that A trusts B and B trusts C. This is calculated by multiplying the trust level of A→B with the trust level of B→C such that the implicit trust level of A→C=A→B*B→C. For example if the trust level of A→B is 0.5 and the trust level of B→C is 0.75, then the trust level of A→C is 0.5*0.75=0.375. In some implementations, the implicit trust levels are discounted by a discount value percentage to account for the fact that determining implicit trust is inherently difficult. Such a discount value might be 10%. For example, if a trust value of 0.375 was calculated using the method above, that value may be discounted by 10% to 0.3375. In some implementations this implicit trust level calculation can be used to determine an implicit trust level for users through any number of user links. In other implementations, the number of user links that can be used is limited. For example, a server system determines that no trust values will be implicitly calculated for users who are more than 2 links away from the current user.

In the trust graph 600 represented in FIG. 6, the first user A has a trust level of 1 618 for user B 604, a trust level of 0.25 626 for user C 606, and a trust level of −0.5 628 for user D 608. User B 604 has a trust level of 0.5 620 for user E 610 and a trust level −0.5 622 for user F 612. The trust calculation module (FIG. 1, 130) calculates the implicit trust level 632 for User A 602 by multiplying the trust level from A→B 618 and the trust level 620 from B→E and then discounting that by 10%. Thus, the implicit trust level 632 from A to E is 1*0.5*0.90=0.45, indicating that there is some trust likely from user A 602 to user B 604. Similarly the implicit trust level 634 from A to F is 1*−0.5*0.90=−0.45, indicating that there is likely some distrust from user A 602 to user F 612. The implicit trust level 636 of A to G is 0.25*1*0.95=0.225.

In some implementations, there is more than one possible connection path that can be used to generate an implicit score. For example, if User A has two different trust levels for User B and User C, and both User B and User C trust User D, the system can use either User B's trust levels or User C's trust level to calculate the implicit trust from User A to User D. In some implementations, the server system (FIG. 1, 120) chooses either highest or lowest potential implicit trust score. In some implementations the server system (FIG. 1, 120) averages all the implicit trust scores. In other implementations, the server system (FIG. 1, 120) selects the implicit trust score that includes the fewest connections.

In some implementations, when a first user A 602 has a trust level lower than 0 for a second user D 608, the trust calculation module (FIG. 1, 130) does not use the trust levels of the second user D 608 to calculate implicit trust levels. Thus, the implicit trust level 638 of A to H is 0 (representing no trust information). In this way no trust information will be inferred though distrusted users. In some implementations no negative trust values are allowed. In other implementations trust information will be inferred through distrusted users in the same way as it is inferred from trusted users.

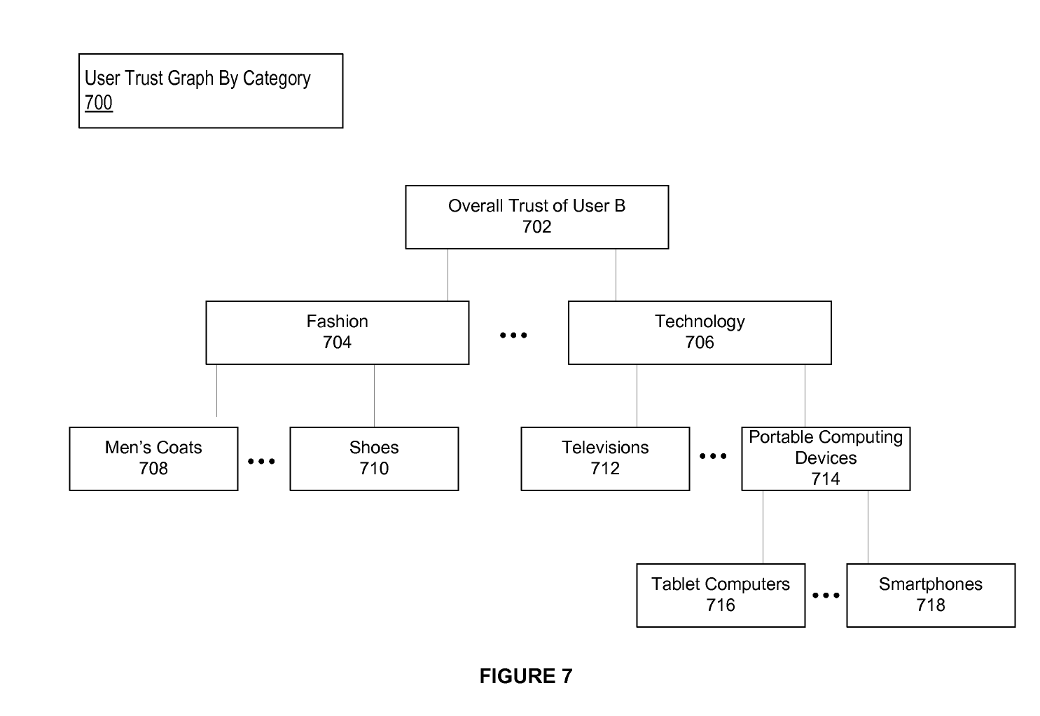

FIG. 7 depicts a block diagram of an exemplary hierarchical trust graph displaying the trust a first user has for a second user B by category. In some implementations a first user may indicate trust in a second user in a particular category of good or service. In this case, the trust information will be stored in a hierarchical trust graph 700. The hierarchical trust graph stores the overall trust level for a user 702. In some implementations, the overall trust level of a second user may be set directly by the first user though a trust indication (FIG. 1, 114). In other implementations, if the first user has not indicated an overall trust level for the second user, the overall trust score is determined by propagating scores for more specific categories lower on the hierarchical trust graph. In some implementations, scores are discounted as they are propagated upwards to more general categories. The scores may be discounted by a fixed percentage, such as 10%. For example, if user A indicates a trust level in portable computing devices 714 of 0.8 that trust level is propagated upwards to technology 706 with a 10% discount. So the trust level from user A to user B in technology 706 would be set to 0.72. The trust level would then be propagated upward to Overall Trust of User B 702 and discounted again and thus given a score of 0.648.

In some implementations, trust levels are also propagated downwards towards more specific categories, and in this case the scores are not discounted. For example, if user A indicates a trust level of 0.5 for user B in the category of fashion 704 this score is propagated downward to all subcategories of fashion 704, including men's coats 708 and shoes 710, at a trust level of 0.5 without any discounting.

In some implementations, when propagating scores from narrow sub-categories to broader categories higher in the hierarchical graph, more than one candidate trust level may be identified from narrower sub-categories. For example, if user A has indicated a trust level of 0.9 for smart phones 718 and a trust level of 0.7 for tablet computers 716, the server system (FIG. 1, 120) needs to determine how to use both levels to determine the overall trust level for portable computing devices 714. In determining the trust level of portable computing devices 714 the trust calculation module (FIG. 1, 130) needs to deal with the trust level of both sub-categories. In some implementations, the trust level of portable computing device 714 uses the higher of the competing trust levels, resulting in a trust level of 0.9. In some implementations, the trust level of portable computing device 714 uses the lower of the two competing trust levels, resulting in a trust level of 07. In some implementations, the two competing trust levels are averaged to produce the trust level of the higher category, resulting in a trust level of 0.8.

In some implementations, every user has a hierarchical trust graph for each trusted user. In other implementations, the system stores category trust information and only builds the hierarchical trust graph when needed.

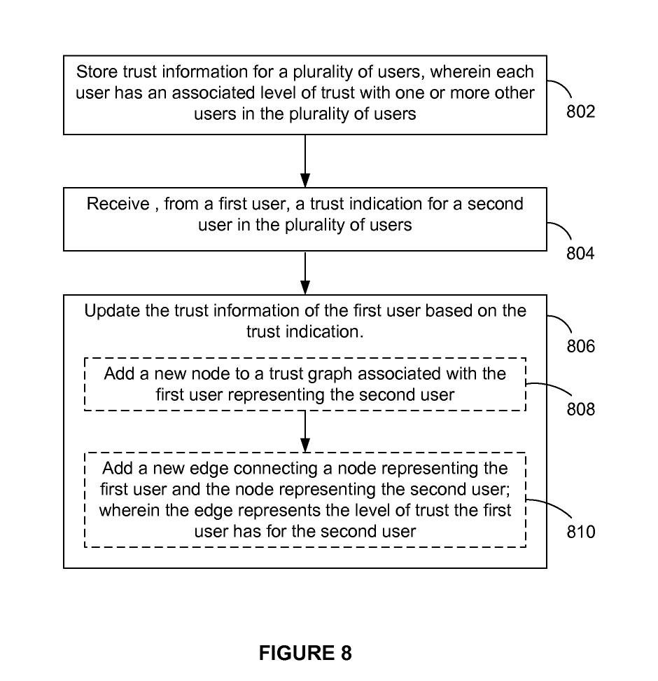

FIG. 8 is a flow diagram illustrating the process for storing levels of trust between users for use in accordance with some implementations. Each of the operations shown in FIG. 8 may correspond to instructions stored in a computer memory or computer readable storage medium. Optional operations are indicated by dashed lines (e.g., boxes with dashed-line borders). In some implementations, the method described in FIG. 8 is performed by the server system (FIG. 1, 120).

In accordance with some implementations, the server system (FIG. 1, 102) stores trust information for a plurality of users, wherein each user has an associated level of trust with one or more other users in the plurality of users (802). In some implementations, the trust information is a trust graph representing levels of trust between at least some of the users in the plurality of users.

In some implementations, the trust graphs are directed graphs. In some implementations, the server system (FIG. 1, 102) receives, from a first user, a trust indication for a second user in the plurality of users (804). In some implementations, the trust indication includes a level of trust from the first user to the second user. In some implementations, the trust indication further includes a trust category from a plurality of trust categories in which the first user trusts the second user. In some implementations, the plurality of trust categories are arranged in a hierarchical format.

In accordance with some implementations, the server system (FIG. 1, 102) updates the trust information of the first user based on the trust indication (806). In some implementations, updating trust information includes adding a new node to a graph associated with the first user representing the second user (808). In some implementations, updating trust information further includes adding a new edge connecting a node representing the first user and the node representing the second user; wherein the edge represents the level of trust the first user has for the second user (810).

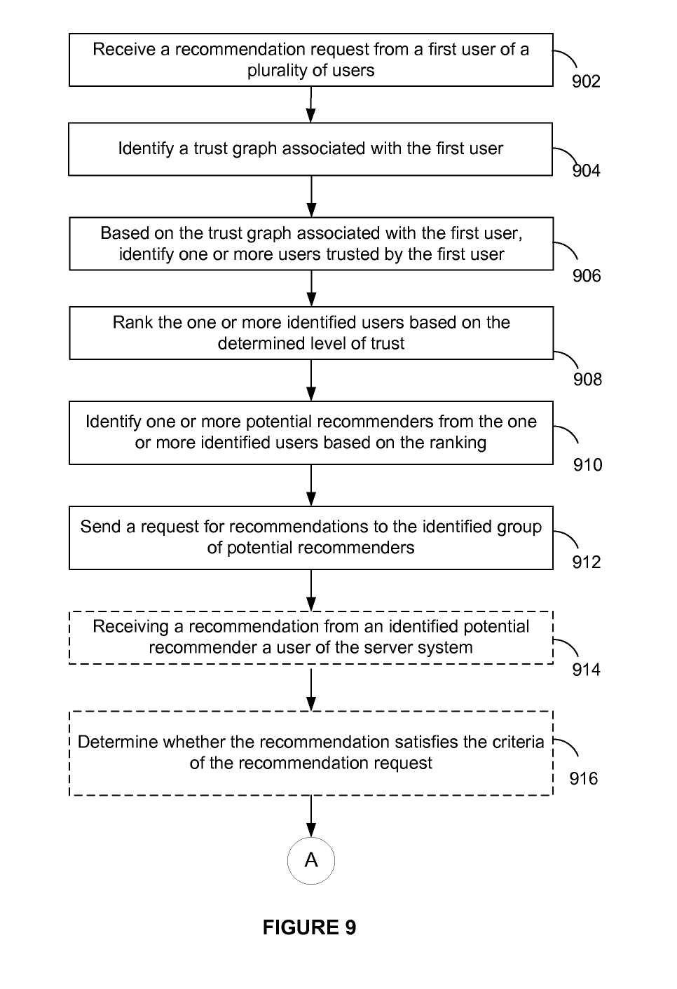

FIG. 9 is a flow diagram illustrating the process for fulfilling a recommendation request in accordance with some implementations. Each of the operations shown in FIG. 9 may correspond to instructions stored in a computer memory or computer readable storage medium. Optional operations are indicated by dashed lines (e.g., boxes with dashed-line borders). In some implementations, the method described in FIG. 9 is performed by the server system (FIG. 1, 120).

In accordance with some implementations, the server system (FIG. 1, 120) receives a recommendation request from a first user of a plurality of users (902). In some implementations the recommendation request includes a category of the product requested. In some implementations the recommendation request includes one or more criteria for evaluating potential recommendations. The one or more criteria can include at least one of the price, style, brand, size, features, and style of the product. In some implementations, the server system (FIG. 1, 120) identifies a trust graph associated with the first user (904). The server system (FIG. 1, 120) then identifies one or more users trusted by the first user, based on the trust graph associated with the first user (906).

In accordance with some implementations, the server system (FIG. 1, 120) ranks the one or more identified users based on the determined level of trust (908). For example, the server system orders the identified users from highest level of trust to lowest level of trust. The server system (FIG. 1, 120) then identifies one or more potential recommenders from the one or more identified users based on the ranking (910). In some implementations, the identified one or more potential recommenders are selected based on the number of communications the users have recently received from the server system (FIG. 1, 120). In this way, the server system (FIG. 1, 120) avoids flooding or overburdening uses with too many recommendation requests. The server system (FIG. 1, 120) sends a request for recommendations to the identified group of potential recommenders (912). In some implementations, requests for recommendations are sent over email. In other implementations, the requests are sent via a server system (FIG. 1, 120) messaging service.

In accordance with some implementations, the server system (FIG. 1, 120) receives a recommendation from an identified potential recommender a user of the server system (FIG. 1, 120) (914). The server system (FIG. 1, 120) determines whether the recommendation satisfies the criteria of the recommendation request (916).

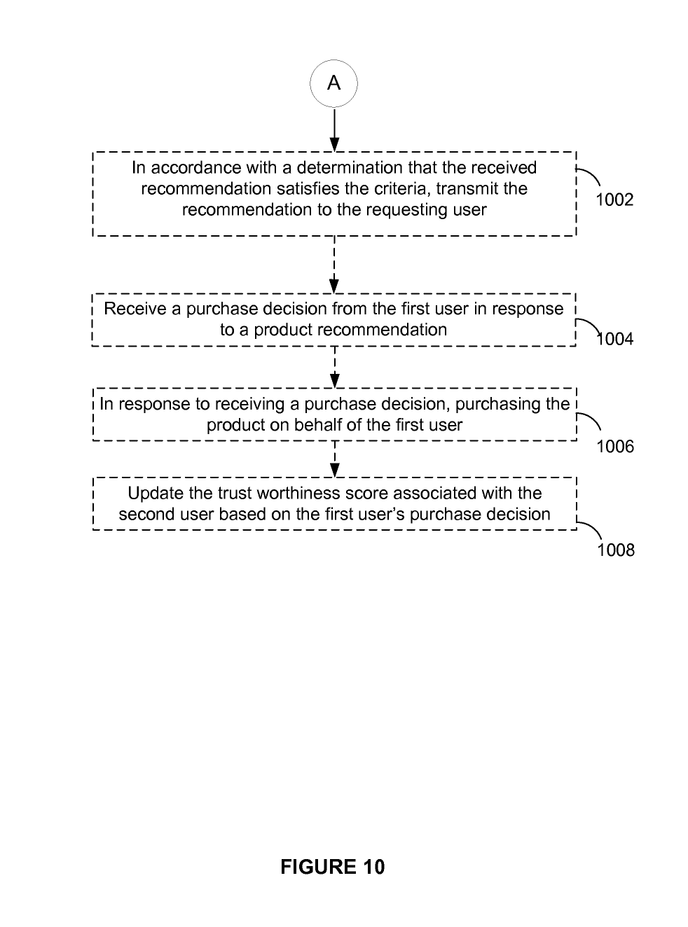

FIG. 10 is a flow diagram illustrating the process for fulfilling a recommendation request in accordance with some implementations. Each of the operations shown in FIG. 10 may correspond to instructions stored in a computer memory or computer readable storage medium. Optional operations are indicated by dashed lines (e.g., boxes with dashed-line borders). In some implementations, the method described in FIG. 10 is performed by the server system (FIG. 1, 120).

In accordance with some implementations, the server system (FIG. 1, 120), in accordance with a determination that the received recommendation satisfies the criteria, transmits the recommendation to the requesting user (1002). The recommendation is sent to the user via any messaging system including, but not limited to e-mail, text messaging, voice messaging, or a messaging service internal to the server system. The server system (FIG. 1, 120) receives a purchase decision from the first user in response to a product recommendation (1004). In some implementations, the user directly responds to the recommendation server sent from the server system. The server system (FIG. 1, 120), in response to receiving a purchase decision, purchases the product on behalf of the first user (1006). The server system (FIG. 1, 120) updates the trust graph associated with the first user based on the purchase decision (1008).

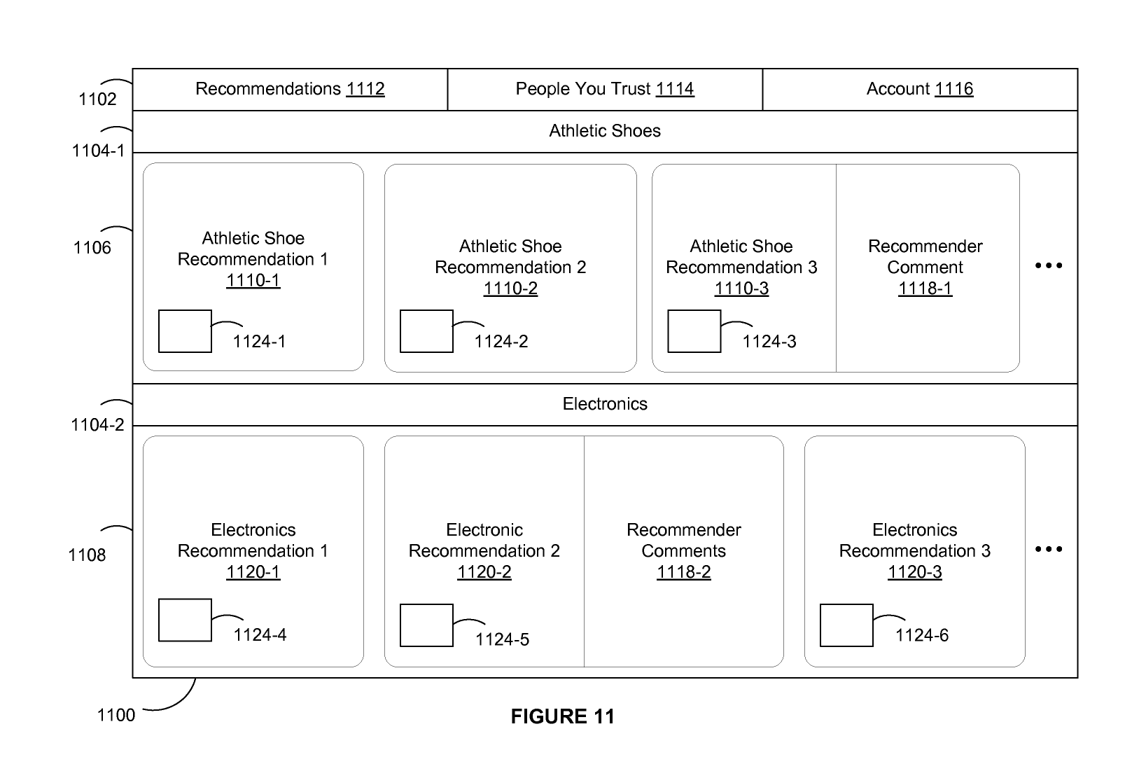

FIG. 11 illustrates an exemplary user interface 1100 displaying recommendations of products to a user of a server system (FIG. 1, 120). In this example, a web browser displays a web page associated with the server system (FIG. 1, 120). The web page includes a navigation bar 1102. The navigation bar 1102 includes a plurality of navigation buttons, for example a “recommendations” button 1112, a “People You Trust” button 1114, and an “Account” button 1116. A user clicks on the various navigation buttons to see different web pages associated with the server system (FIG. 1, 120).

In some implementations the user selects the “Recommendations” navigation button 1112. In response, the server system (FIG. 1, 120) transmits a recommendations web page to the user for display. In this example, the web page includes a plurality of product category areas (1104-1 and 1104-2). The server system (FIG. 1, 120) determines the displayed categories based on the user's interests. Each category area 1104 includes a plurality of product recommendations (1110-1, 1110-2, 1110-3, 1120-1, 1120-2, and 1120-3) and associated images. In this example, the Athletic Shoes area (1104-1) includes three athletic shoe recommendations (1110-1, 1110-2, and 1110-3).

In some implementations, each recommendation includes an indication of the recommender (1124-1-1124-6). In some implementations the indication is an image associated with the recommender. In other implementations, the indication is the name of the recommender listed in text. In yet other implementations, the indication is a link to the profile of the recommender. Some implementations include all or some of the above listed indications. In some implementations, the recommendations also include a user interface element, such as a link, button, or other user interface element, (not pictured) that allows the user to request the recommendation source information for that recommendation.

In some implementations, a recommendation (1110 includes recommender comments (1118-1 or 1118-2) that describe some or all of the recommender's thoughts on the recommended product in more detail. In some implementations, every recommendation has an associated recommender comment, but they are only shown upon user request. In some implementations, only relevant portions of the comment are shown.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present implementations. The first contact and the second contact are both contacts, but they are not the same contact.

The terminology used in the description of the implementations herein is for the purpose of describing particular implementations only and is not intended to be limiting. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if (a stated condition or event) is detected” may be construed to mean “upon determining” or “in response to determining” or “upon detecting (the stated condition or event)” or “in response to detecting (the stated condition or event),” depending on the context.

What is claimed is:

1. A method for storing levels of trust between users for use in commerce, comprising:
at a server system having one or more processors and memory storing one or more programs for execution by the one or more processors:
storing trust information for a plurality of users, wherein each user has an associated level of trust with one or more other users in the plurality of users;
receiving, from a first user, a trust indication for a second user in the plurality of users; and
updating the trust information of the first user based on the trust indication.

2. The method of claim 1, wherein the trust information is a trust graph representing levels of trust between at least some of the users in the plurality of users.

3. The method of claim 2, wherein the trust graph is a directed graph of trust between users.

4. The method of claim 1, wherein the trust indication includes a level of trust from the first user to the second user.

5. The method of claim 1, wherein the trust indication further includes a trust category from a plurality of trust categories in which the first user trusts the second user.

6. The method of claim 5, wherein the plurality of trust categories are arranged in a hierarchical format.

7. The method of claim 2, wherein the nodes in the trust graph represent users and the edges in the trust graph represents levels of trust.

8. The method of claim 7, wherein particular edges further represent a particular trust category.

9. The method of claim 7, wherein the updating the trust information includes:
adding a new node to a trust graph representing the second user, and
adding a new edge connecting a node representing the first user and the node representing the second user; wherein the edge represents the level of trust the first user has for the second user.

10. A method for fulfilling a recommendation request, comprising:
at a server system having one or more processors and memory storing one or more programs for execution by the one or more processors:
receiving a recommendation request from a first user of a plurality of users;
identifying a trust graph associated with the first user;
based on the trust graph associated with the first user, identifying one or more users trusted by the first user;
ranking the one or more identified users based on the determined level of trust;
identifying one or more potential recommenders from the one or more identified users based on the ranking; and
sending a request for recommendations to the identified group of potential recommenders.

11. The method of claim 10, wherein the recommendation request includes a category of requested product.

12. The method of claim 10, wherein the trust graph includes a plurality of users associated with the first user.

13. The method of claim 10, wherein the recommendation request includes one or more criteria for evaluating potential recommendations.

14. The method of claim 10, further including:
receiving a recommendation from an identified potential recommender a user of the server system;
determining whether the recommendation satisfies the criteria of the recommendation request; and
in accordance with a determination that the received recommendation satisfies the criteria, transmitting the recommendation to the requesting user.

15. The method of claim 10, further including:
receiving a purchase decision from the first user in response to a product recommendation; and
in response to receiving a purchase decision, purchasing the product on behalf of the first user.

16. The method of claim 15, further including:
updating the trust worthiness score associated with the second user based on the first user's purchase decision.

17. An electronic device for storing levels of trust between users for use in online e-commerce, comprising:
one or more processors and
memory storing one or more programs to be executed by the one or more processors;
the one or more programs comprising instructions for:
storing trust information for a plurality of users, wherein each user has an associated level of trust with one or more other users in the plurality of users;
receiving, from a first user in the plurality of users, a trust indication for a second user in the plurality of users; and
updating the trust information of the first user based on the trust indication.

18. An electronic device for fulfilling a recommendation request, comprising:
one or more processors and
memory storing one or more programs to be executed by the one or more processors;
the one or more programs comprising instructions for:
receiving a recommendation request from a first user of a plurality of users;
determining a trust graph associated with the first user;
based on the trust graph associated with the first user, identifying one or more users trusted by the first user;
ranking the one or more identified users based on the determined level of trust;
identifying one or more potential recommenders from the one or more identified users based on the ranking; and
sending a request for recommendations to the identified group of potential recommenders.

19. A non-transitory computer readable storage medium storing one or more programs configured for execution by an electronic device, the one or more programs comprising instructions for:
storing trust information for a plurality of users, wherein each user has an associated level of trust with one or more other users in the plurality of users;
receiving, from a first user in the plurality of users, a trust indication for a second user in the plurality of users; and
updating the trust information of the first user based on the trust indication.

20. A non-transitory computer readable storage medium storing one or more programs configured for execution by an electronic device, the one or more programs comprising instructions for:
receiving a recommendation request from a first user of a plurality of users;
determining a trust graph associated with the first user;
based on the trust graph associated with the first user, identifying one or more users trusted by the first user;
ranking the one or more identified users based on the determined level of trust;
identifying one or more potential recommenders from the one or more identified users based on the ranking; and
sending a request for recommendations to the identified group of potential recommenders.
